(19) United States
(12) Patent Application Publication
(10) Pub. No.: US 2002/0058521 A1
(43) Pub. Date: May 16, 2002

(54) Distribution system capable of easy registration or renewal of ringing tone, and cellular phone used therefor

(75) Inventors: Takashi Yamada, Yamagata-gun (JP); Shoji Goto, Gifu-shi (JP)

Correspondence Address: ARMSTRONG,WESTERMAN & HATTORI, LLP, 1725 K STREET, NW., SUITE 1000, WASHINGTON, DC, 20006, US

(73) Assignee: Sanyo Electric Co., Ltd., Moriguchi-shi (JP)

(21) Appl. No.: 09/986,970

(22) Filed: Nov. 13, 2001

(30) Foreign Application Priority Data
Nov. 15, 2000 (JP) 2000-347842(P)

(51) Int. Cl. H04Q 7/20

(52) U.S. Cl. 455/458; 455/567; 455/419

(57) ABSTRACT

The user of a cellular phone accesses a server using his/her own cellular phone via a base station, a telephone communication network and a base station control unit, to make a distribution request for music content data. The server distributes the requested music content data and a ringing tone to the cellular phone after the authentication of the accessing cellular phone is verified. Here, the user of the cellular phone only pays the price for music content data. Therefore, the user of the cellular phone can easily register or renew ringing tones.

### BACKGROUND OF THE INVENTION

1. Field of the Invention

The present invention relates to a distribution system distributing ringing tones to users together with content data, and to a cellular phone receiving the content data and ringing tones.

2. Description of the Background Art

In recent years, as information technology (IT) has been developed, cellular phones have come to serve as mobile terminal devices for transmitting/receiving various information, in addition to the primary telecommunication function. In other words, cellular phones perform reception of various information as well as transmission/reception of electronic mails via the Internet.

Moreover, recently, services for distributing music data are performed via the Internet. For example, a company selling music CDs (Compact Disks) distributes music data free of charge via the Internet for a user to listen to the distributed music data. The user may purchase a music CD in which the music data is recorded, resulting in increase of the sales figures of music CDs. As such, music distribution via the Internet is used as advertisement of music CDs. Furthermore, music data may also be distributed to users for the purpose of sales, not of advertisement, via the Internet or stations installed in convenience stores.

A cellular phone has a ringing-tone function for signaling to the user of the cellular phone that there is an incoming call. The ringing tones are much the same for different cellular phone manufacturers. Thus, when a plurality of cellular phones simultaneously receive calls, it is difficult to identify a particular cellular phone. Under these circumstances, recently, the users of cellular phones can register ringing tones of their preferences into the cellular phones. A ringing tone can be registered into a cellular phone by entering each musical note using keys provided on the cellular phone, or by selecting a ringing tone of the user's preference from a plurality of ringing tones pre-installed in the purchased cellular phone.

Recently, in some models, so-called “ringing-tone services” are provided in that ringing tones are distributed via the E-mail services for cellular phones, and the user purchases a desired ringing tone therefrom and downloads the musical note data of the purchased ringing tone to capture the data into the cellular phone as a ringing tone. In such ringing-tone services, the user performs a series of processes, i.e. setting of the cellular phone to be in a connected state, accessing to a tone-distributing center, test-listening of ringing tones, selection, downloading, and registration.

As described above, provision of various services are attempted using cellular phones, and hence various content data such as image data and map data, not limited to music data, may also be distributed.

However, when the user selects a ringing tone from a plurality of types of ringing patterns or tones as described above, only limited number of ringing patterns or tones can be provided, and there is no guarantee that the user can find a desired ringing tone. Moreover, when a ringing tone is created manually by entering musical notes one by one, it is troublesome and takes a long time to enter the entire tune. Furthermore, according to the method for the ringing-tone services described above, the user must maintain the line connected with the distributing center for a period from accessing to the center until downloading and registration of a ringing tone, and the user must bear the expenses for the call. Thus, even in downloading the data of a ringing tone that is compressed to be small, the user must go through a complicated distribution procedure, and moreover, is required to pay for dialing charges every time.

### SUMMARY OF THE INVENTION

Therefore, an object of the present invention is to provide a distribution system of content data and a cellular phone, in which a ringing tone can easily be registered or renewed.

According to one aspect of the present invention, a distribution system includes a server holding content data and a ringing tone, and distributing the content data and the ringing tone in accordance with a request for distribution (hereinafter also referred to as distribution request) of the content data; and a cellular phone transmitting the distribution request for the content data to the server, and receiving the ringing tone together with the content data from the server.

In the distribution system according to the present invention, when the cellular phone issues the distribution request for content data to the server, the server transmits the content data and a ringing tone to the cellular phone in response to the distribution request. Therefore, according to the present invention, the user of the cellular phone can also receive the ringing tone at the time of receiving the content data. As a result, the user can easily receive the ringing tone by his/her cellular phone.

Preferably, the cellular phone transmits authentication data in accordance with a request for transmission of the authentication data from the server, and receives the content data and ringing tone in response to authentication of the authentication data being verified by the server.

The cellular phone transmits the authentication data to the server, and receives the content data and ringing tone after the server determined that the access is from an authorized cellular phone. Therefore, according to the present invention, the ringing tone can be distributed together with the content data only to the user of the authorized cellular phone.

Preferably, the server extracts and regenerates a ringing tone in response to the distribution request for the content data, and transmits the regenerated ringing tone to the cellular phone; and the cellular phone transmits the distribution request for the ringing tone to the server in response to the distribution request for the ringing tone being entered.

The cellular phone receives the ringing tone regenerated at the server while maintaining the line connected with the server. Then, the user of the cellular phone listens to the ringing tone as a trial and thereafter enters a request/no-request for distribution of the ringing tone. When the user enters the request for distribution of the ringing tone, the cellular phone transmits the distribution request to the server. Therefore, according to the present invention, the user can actually listen to the ringing tone before determining if he/she wishes to receive distribution of the ringing tone, so as to receive only a desired ringing tone.

Preferably, the cellular phone receives the ringing tone only when the distribution request for the ringing tone is transmitted to the server.

In sending the distribution request for content data to the server, the cellular phone determines whether or not it requests distribution of the ringing tone, and issues the distribution request for the ringing tone only when required. Therefore, according to the present invention, the user of the cellular phone can renew the ringing tone whenever he/she wishes to.

Preferably, the content data is music data, and the server distributes to the cellular phone, as the ringing tone, a tune related to music data of which distribution is requested.

When distribution of music content data is requested, the server distributes to the cellular phone a ringing tone related to the music content data together with the music content data. Therefore, according to the present invention, the user can set a tune to which he/she likes to listen as a ringing tone.

Preferably, the content data is music data, and the server distributes to the cellular phone, as the ringing tone, a part of music data for which distribution request is issued at least a predetermined number of times.

When the server receives the distribution request for music content data, it transmits to the cellular phone a part of a tune that is high on the chart, as a ringing tone. Therefore, according to the present invention, the user can set a hit tune as a ringing tone for the cellular phone.

Preferably, the content data is music data, and the server distributes to the cellular phone a ringing tone determined based on a category to which requested music data belongs.

The distribution request for music content data is received, the server transmits to the cellular phone the ringing tone determined for a category to which the music content data of the distribution request belongs. Therefore, according to the present invention, the cellular phone can receive the same ringing tone as long as it requests distribution of music content data in the same category.

Preferably, the cellular phone receives the content data and ringing tone from the server while no telephone call is in progress.

Therefore, according to the present invention, the user can receive the content data at lower expenses.

Preferably, a user of the cellular phone only pays the price for the content data to the server.

The user of the cellular phone receives a ringing tone free of charge, together with the content data. Therefore, according to the present invention, the user of the cellular phone can receive the ringing tone as an extra give-away.

According to another aspect of the present invention, a cellular phone receiving a ringing tone together with content data from a server holding the content data and ringing tone includes a transmission/reception unit communicating with the server; a memory unit storing the content data and ringing tone; a ringing tone generating unit; a key operation unit for entering an instruction; and a control unit. The control unit transmits a request for distribution of the content data, entered from the key operation unit, to the server via the transmission/reception unit in response to the distribution request, inputting the content data and ringing tone received via the transmission/reception unit into the memory unit, and setting the received ringing tone to the ringing tone generating unit. The ringing tone generating unit generates the set ringing tone when the control unit receives a normal call via the transmission/reception unit.

In the cellular phone according to the present invention, when the distribution request for content data is entered via the key operation unit, the cellular phone transmits the distribution request for content data to the server, and receives the content data and a ringing tone from the server. The received content data and ringing tone are stored into the memory, and the ringing tone is set to the ringing tone generating unit. When there is an incoming call from another cellular phone, the ringing tone generating unit generates the newly-set ringing tone. Therefore, according to the present invention, the cellular phone can automatically set the ringing tone received together with the content data.

Preferably, the control unit reads authentication data stored in the memory unit in response to a request for transmission of the authentication data from the server, transmits the read authentication data to the server via the transmission/reception unit, and receives the content data and ringing tone via the transmission/reception unit in response to authentication of the authentication data being verified by the server.

The control unit of the cellular phone reads the authentication data from the memory in response to the request for the authentication data from the server, and transmits the read authentication data to the server. The cellular phone then receives the content data and ringing tone in response to the authentication of authentication data being verified by the server. Therefore, according to the present invention, the content data and ringing tone can be transmitted only to an authorized cellular phone.

Preferably, the control unit receives the ringing tone only when the distribution request for the ringing tone is transmitted to the server via the transmission/reception unit.

The cellular phone arbitrarily issues the distribution request for the ringing tone to the server, and receives the ringing tone from the server only when the distribution request for the ringing tone is issued. Therefore, according to the present invention, the user of the cellular phone can receive the ringing tone only when he/she desires distribution of the ringing tone.

Preferably, the cellular phone further includes an output unit outputting the ringing tone to outside the cellular phone. The control unit receives a ringing tone regenerated at the server via the transmission/reception unit, supplies the received ringing tone to the output unit, and transmits the distribution request for the ringing tone to the server via the transmission/reception unit in response to the distribution request for the ringing tone being entered via the key operation unit.

The user of the cellular phone listens to the ringing tone regenerated in the server as a trial, and the cellular phone receives the ringing tone only when the user desires distribution of the ringing tone. Therefore, according to the present invention, the user can actually test-listen to the ringing tone in order to determine whether or not he/she receives distribution of the ringing tone, and receives only a desired ringing tone.

Preferably, the content data is music data, and the control unit receives, as the ringing tone, a tune related to music data of which distribution is requested.

The cellular phone receives a ringing tone related to the requested music content data. Therefore, according to the present invention, the user can set the tune to which he/she likes to listen, as the ringing tone for the cellular phone.

Preferably, the content data is music data, and the control unit receives, as the ringing tone, a part of music data for which a distribution request is issued to the server at least a predetermined number of times.

When the distribution request for music content data is transmitted to the server, the cellular phone receives a part of the tune that is high on the chart as a ringing tone. Therefore, according to the present invention, the user can set a hit tune as the ringing tone for the cellular phone.

Preferably, the content data is music data, and the control unit of the cellular phone receives a ringing tone determined based on a category to which requested music data belongs.

When the distribution request for music content data is transmitted, the cellular phone receives a ringing tone determined for the category to which the requested music content data belongs. Therefore, according to the present invention, the cellular phone can receive the same ringing tone as long as the distribution request is issued for the music content data in the same category.

Preferably, the control unit receives the content data and ringing tone while no telephone call is in progress.

The cellular phone receives the content data and ringing tone while no telephone call is in progress. Therefore, according to the present invention, the user of the cellular phone can receive the content data at lower expenses.

Preferably, the control unit reads the received ringing tone from the memory unit in accordance with a request for setting a ringing tone entered via the key operation unit, and supplies the read ringing tone to the ringing tone generating unit.

The control unit of the cellular phone reads a ringing tone from the memory unit when the request for setting the ringing tone is entered via the key operation unit, and sets the read ringing tone to the ringing tone generating unit. Therefore, according to the present invention, the user can set the ringing tone whenever he/she wishes to.

According to a further aspect of the present invention, a distribution system includes a cellular phone issuing a distribution request for content data, receiving the content data and a ringing tone, and setting the ringing tone; a supplier distributing the content data and ringing tone to the cellular phone in response to the distribution request for the content data from the cellular phone; and a content provider providing the supplier with the content data. A user of the cellular phone only pays a price for the content data to the supplier. The supplier pays a price for the content data to the content provider, and receives advertisement expenses and sales commission for the content data from the content provider.

In the distribution system according to the present invention, the user of the cellular phone sends the distribution request for the content data to the supplier using his/her own cellular phone, receives the content data and a ringing tone from the supplier, and sets the ringing tone to the cellular phone. Moreover, the supplier is provided with content data by a content provider. The user of the cellular phone only pays the price for the content data to the supplier, and the supplier pays the price for the content data to the content provider and receives advertisement expenses and sale commission from the content provider. In other words, the content provider and supplier receive no charge for ringing tones, and use the ringing tones as advertisement for encouraging distribution of the content data. It is noted that the phrase “only the price for the content data” paid by the user of the cellular phone means only the price for the content data between the prices for the content data and ringing tone. This does not exclude the minimum charge and dialing charges for the cellular phone paid by the user. Therefore, according to the present invention, the user of the cellular phone can receive a ringing tone and automatically set the ringing tone to his/her own cellular phone only by paying the price for the content data of which the user desires for distribution.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic view for schematically illustrating a distribution system of music content data according to the present invention;

FIG. 2 is a block diagram for illustrating the function of a server shown in FIG. 1;

FIG. 3 is a block diagram for illustrating a configuration of a cellular phone shown in FIG. 1;

FIG. 4 is the first flow chart for illustrating distributing operation for music content data;

FIG. 5 is the second flow chart for illustrating distribution operation for music content data;

FIG. 6 shows a category list displayed on a display unit of a cellular phone;

FIG. 7 shows a title list displayed on a display unit of a cellular phone;

FIG. 8 is the first flow chart for illustrating another distributing operation for music content data;

FIG. 9 is the second flow chart for illustrating another distributing operation for music content data;

FIG. 10 is the first flow chart for illustrating a further distribution operation for music content data; and

FIG. 11 is a schematic view for schematically illustrating a business model according to the present invention.

### DESCRIPTION OF THE PREFERRED EMBODIMENTS

Embodiments of the present invention will be described in detail with reference to the drawings. It is noted that the same or corresponding portions in the drawings are denoted by the same reference characters, and the description thereof will not be repeated.

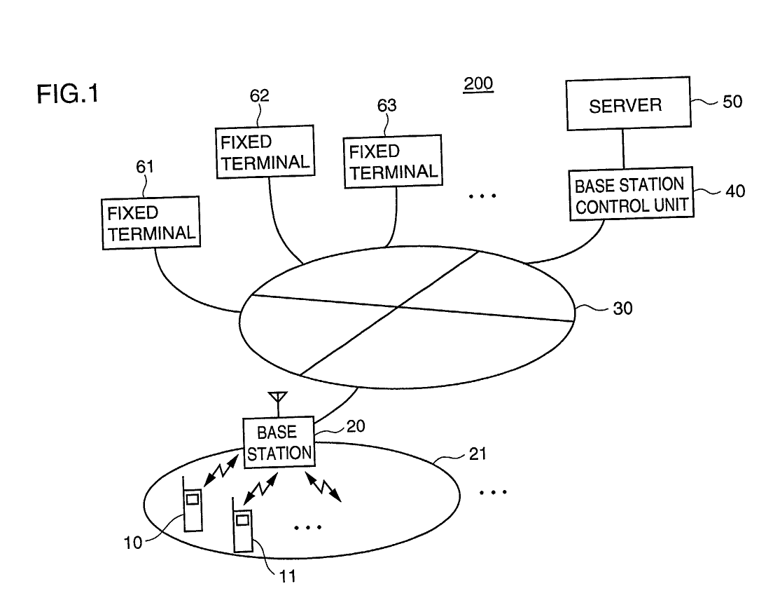

Referring to FIG. 1, a distribution system of music content data according to an embodiment of the present invention is schematically described. A distribution system 200 includes cellular phones 10, 11, . . . , a base station 20, a telephone communication network 30, a base station control unit 40, and a server 50. Cellular phones 10, 11, . . . and base station 20 constitute a base station area 21, in which base station 20 communicates with each of cellular phones 10,11, . . . by radio. Moreover, fixed terminals 61, 62, 63, . . . are connected to telephone communication network 30, and can communicate with cellular phones 10, 11, . . . via telephone communication network 30. Server 50 is connected to telephone communication network 30 via base station control unit 40, and can distribute music content data and ringing tones to cellular phones 10, 11, . . . via telephone communication network 30 and base station 20. Server 50 distributes no music content data and ringing tones to fix terminals 61, 62, 63, . . . . Fixed terminals 61, 62, 63, . . . are shown only to indicate that the music content data and ringing tones are distributed from server 50 to cellular phones 10, 11, . . . via the existing telephone communication network 30 to which fixed terminals 61, 62, 63, . . . such as telephones installed in ordinary households are connected, not to indicate that fixed terminals 61, 62, 63, . . . are used as terminals to which the music content data and ringing tones are distributed from server 50.

When each user of cellular phones 10, 11, . . . desires distribution of music content data, the user calls server 50 to make a distribution request for music content data. For example, when the user of cellular phone 10 desires distribution of music content data, the user of cellular phone 10 calls server 50. Then, a communication signal from cellular phone 10 passes through base station 20 and telephone communication network 30 and reaches base station control unit 40. Base station control unit 40 controls the communication signal transmitted via base station 20 and communication signals transmitted via other base stations (not shown), and sequentially transmits each communication signal to server 50. Server 50 then receives the communication signal, and a line is connected between server 50 and cellular phone 10 which is connected to base station 20.

Server 50 distributes music content data and ringing tones to cellular phone 10 via base station control unit 40, telephone communication network 30 and base station 20 by the method which will be described later.

Thus, music content data and ringing tones are distributed from server 50 to cellular phones 10, 11, . . . via the existing telephone communication network 30.

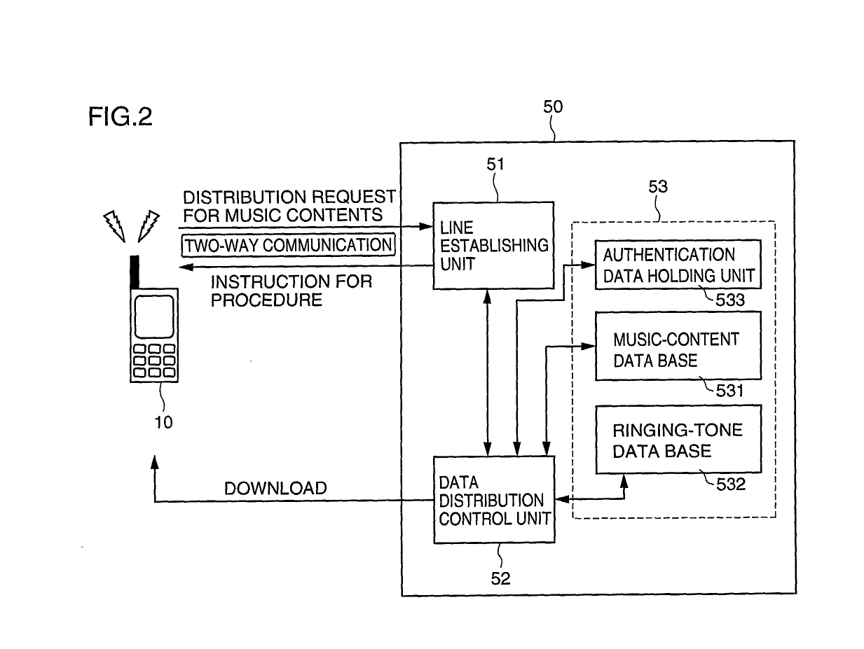

Referring to FIG. 2, the function of server 50 is described in distribution of music content data and ringing tones to cellular phone 10. Server 50 includes a line establishing unit 51, a data distribution control unit 52 and a database unit 53. Database unit 53 includes a music-content data base 531, a ringing-tone data base 532 and an authentication-data holding portion 533.

When a distribution request for music content data is received from cellular phone 10, line establishing unit 51 establishes two-way communication between unit 51 and cellular phone 10. In addition, line establishing unit 51 issues a request for terminal information to cellular phone 10 via two-way communication under the control of data distribution control unit 52. When the terminal information is received from cellular phone 10, line establishing unit 51 outputs the received terminal information to data distribution control unit 52. The terminal information is used for determining whether or not cellular phone 10 is an authorized cellular phone, i.e., this information is authentication data used for authenticating cellular phone 10. The authentication data normally includes the telephone number, the name of the user, the contract number and so forth of cellular phone 10.

Furthermore, when a signal indicating that cellular phone 10 have been authenticated as an authorized cellular phone is received from data distribution control unit 52, line establishing unit 51 transmits a category list of music content data to cellular phone 10 via two-way communication, and receives from cellular phone 10 a category number of a category selected from the category list. Thereafter, line establishing unit 51 transmits a title list of tunes included in the selected category to cellular phone 10. Line establishing unit 51 holds the category list and title list to identify music content data to be distributed when there is a distribution request for music content data. When the number corresponding to the selected music content data is received from cellular phone 10, line establishing unit 51 outputs the number to data distribution control unit 52.

Data distribution control unit 52 compares the terminal information received from cellular phone 10 by line establishing unit 51 with the authentication data held in authentication-data holding portion 533 of database unit 53 in order to determine whether or not cellular phone 10 that has accessed server 50 is an authorized cellular phone. When it is determined that cellular phone 10 is an authorized cellular phone, data distribution control unit 52 transmits a signal indicating as such to line establishing unit 51. Moreover, when the number of the selected music content data is received from line establishing unit 51, data distribution control unit 52 extracts music content data corresponding to that number from music-content data base 531, and also extracts a ringing tone from ringing-tone data base 532, to distribute the extracted music content data and ringing tone to cellular phone 10 via a communication device (not shown). Data distribution control unit 52 extracts the ringing tone by one of the following manners: a tune related to the selected music content data is selected as a ringing tone; a part of a tune that has been accessed a large number of times is selected as a ringing tone in accordance with the descending order of the number of accessed times to server 50; or a ringing tone that is determined per category is selected. When the distribution of music content data and ringing tone to cellular phone 10 is terminated, data distribution control unit 52 transmits a signal indicating the end of distribution (hereinafter referred to as distribution end signal) to cellular phone 10 via a communication device (not shown).

Music-content data base 531 holds various types of music content data. For example, music-content data base 531 holds music content data of different categories such as Enka or traditional Japanese popular ballad, rock music, J-pop or latest Japanese popular music, and so forth.

Ringing-tone data base 532 holds various types of ringing tones. Music content data and ringing tones are held in music-content data base 531 and ringing-tone data base 532 respectively, as compression data compressed by MP3 system (Layer 3 system of MPEG-1 Audio).

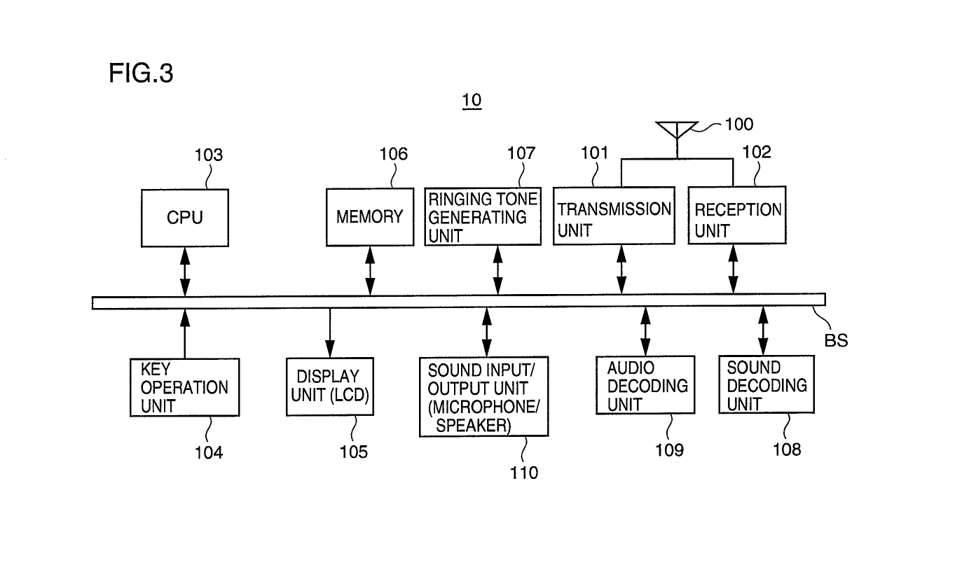

Referring to FIG. 3, the configuration of cellular phone 10 is described. Cellular phone 10 includes a bus BS, an antenna 100, a transmission unit 101, a reception unit 102, a CPU (Central Processing Unit) 103, a key operation unit 104, a display unit 105, a memory 106, a ringing tone generating unit 107, a sound decoding unit 108, an audio decoding unit 109, and a sound input/output unit 110.

Antenna 100 receives a signal from base station 20 and outputs the received signal to reception unit 102, and also transmits a signal from transmission unit 101 to base station 20. Transmission unit 101 receives from bus BS a signal to be transmitted to base station 20, modulates the signal such that the signal corresponds to a predetermined communication system, and outputs the modulated signal to antenna 100. Reception unit 102 demodulates the signal received from antenna 100 and applies the demodulated signal to bus BS.

CPU 103 receives via bus BS the music content data and ringing tone that were received by reception unit 102, and writes the music content data and ringing tone into memory 106. Moreover, CPU 103 reads the ringing tone written in memory 106 via bus BS, and applies the read signal to ringing tone generating unit 107 to set a ringing tone. Furthermore, CPU 103 controls, in addition to the above, each of the units constituting cellular phone 10. Key operation unit 104 is for the user to enter various instructions by key operation. Display unit 105 is to provide the user with the category list and title list sent from server 50, as visual information. Display unit 105 is constituted by an LCD (Liquid Crystal Display). Memory 106 stores the music content data and ringing tone received from server 50. Memory 106 also stores authentication data indicating that cellular phone 10 is an authorized cellular phone. Memory 106 is constituted by, for example, a non-volatile memory such as an EEPROM.

Ringing tone generating unit 107 generates a ringing tone in accordance with the set ringing tone when there is an incoming call from another cellular phone, and outputs the generated ringing tone to sound input/output unit 110 via bus BS. In communication with another cellular phone, sound decoding unit 108 decodes sound data on the other end of the line that is received by reception unit 102. Audio decoding unit 109 decodes music content data stored in memory 106. Specifically, audio decoding unit 109 decompresses the music content data compressed by the MP3 system.

Sound input/output unit 110 outputs a sound signal decoded by sound decoding unit 108 and music data decoded by audio decoding unit 109 to the outside, and also inputs sound data produced by the user of cellular phone 10. Sound input/output unit 110 is constituted by a microphone and a speaker.

It is noted that only the components related to the distribution operation for music content data are shown in FIG. 3, and the components for communication function or the like that is an inherent feature of a cellular phone are not shown.

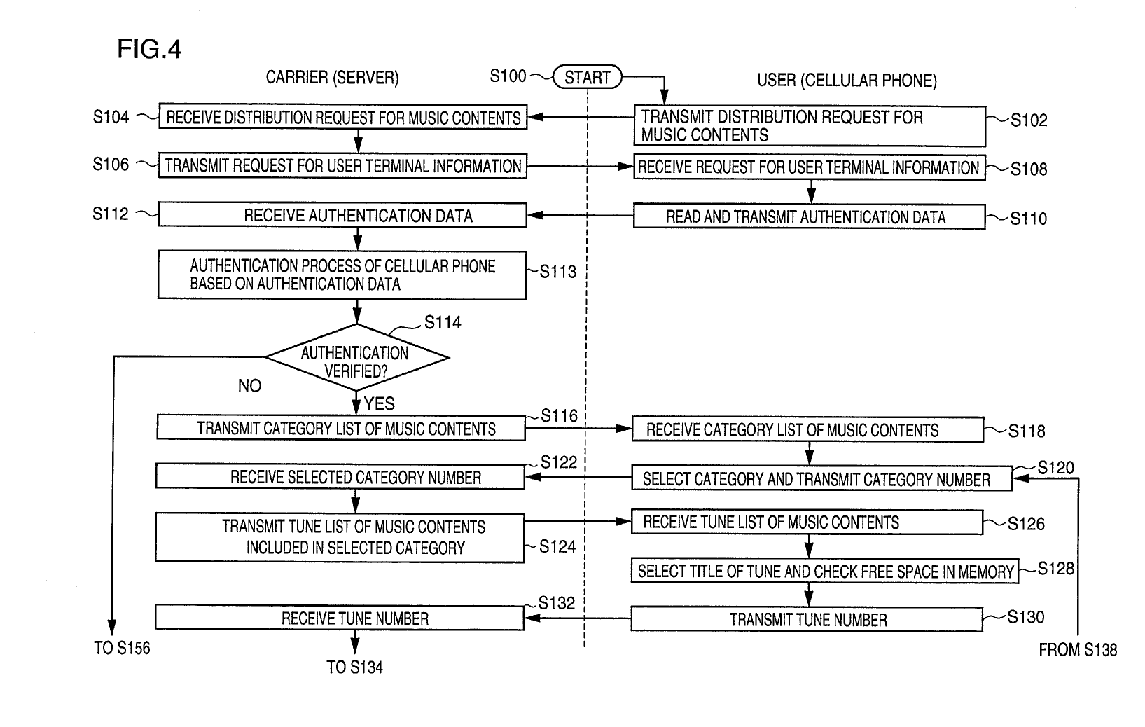

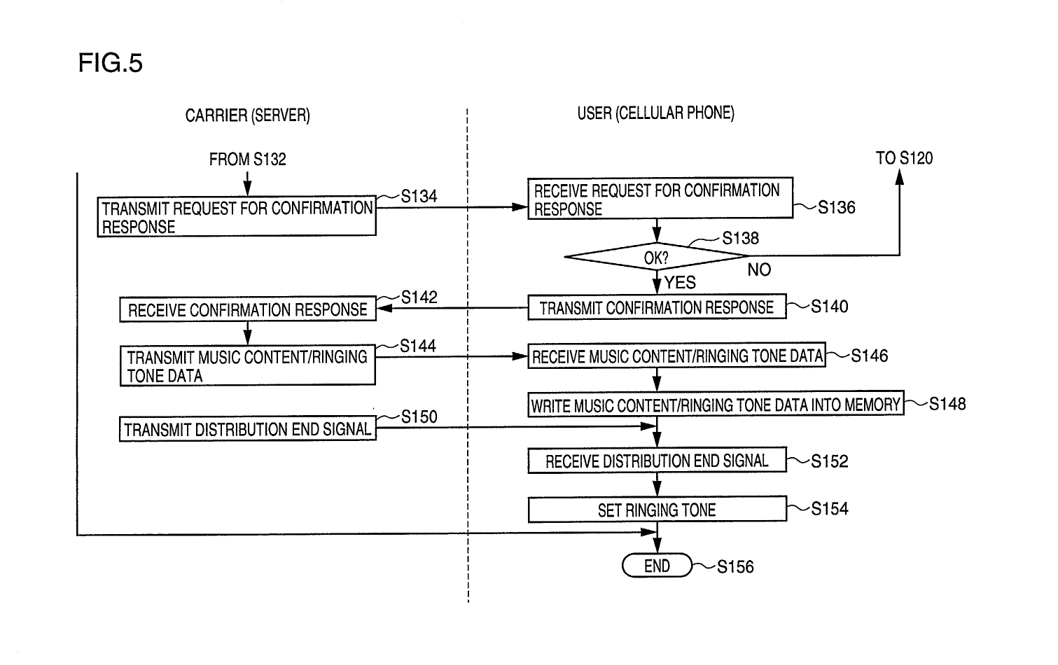

Referring to FIGS. 4 and 5, the flow chart for illustrating reception of music content data and ringing tone from server 50 will be described. First, referring to FIG. 4, when downloading of music content data is started (step S100), the user of cellular phone 10 calls server 50 to transmit a distribution request for music contents (step S102). Line establishing unit 51 of server 50 receives the distribution request for music contents, and establishes two-way communication with cellular phone 10 (step S104). Line establishing unit 51 then outputs a signal to data distribution control unit 52, indicating that the distribution request for music contents has been received from cellular phone 10. Then, data distribution control unit 52 controls line establishing unit 51 such that a request for user terminal information is issued, and thus line establishing unit 51 transmits the request for user terminal information to cellular phone 10 via two-way communication (step S106). CPU 103 of cellular phone 10 receives the request for user terminal information via antenna 100, reception unit 102 and bus BS, reads authentication data of cellular phone 10 from memory 106 via bus BS, and transmits the read authentication data to server 50 via bus BS, transmission unit 101 and antenna 100 (step S110).

Line establishing unit 51 of server 50 receives the authentication data from cellular phone 10 (step S112), and outputs the received authentication data to data distribution control unit 52. Thereafter, data distribution control unit 52 performs an authentication process for cellular phone 10 by comparing the authentication data input from line establishing unit 51 with the authentication data held in authentication-data holding portion 533 (step S113). When the authentication data sent from cellular phone 10 agrees with the authentication data held in authentication-data holding portion 533, data distribution control unit 52 determines that cellular phone 10 is authenticated, whereas if the authentication data sent from cellular phone 10 disagrees with the authentication data held in authentication-data holding portion 533, data distribution control unit 52 determines that cellular phone 10 is not authenticated (step S114). If cellular phone 10 is not authenticated at step S114, the process moves on to step S156 in FIG. 5, to terminate the distribution operation for music content data.

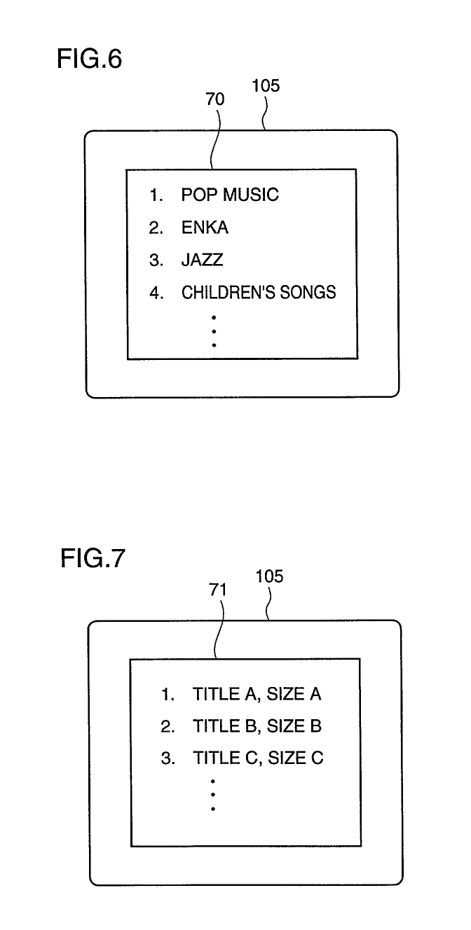

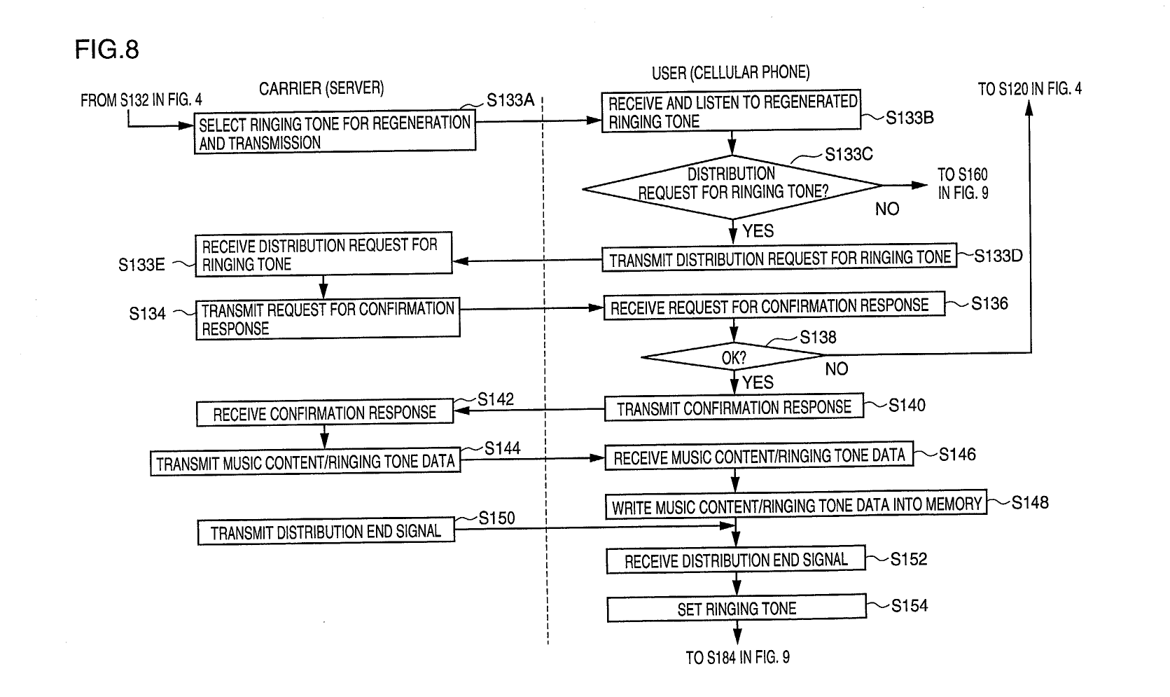

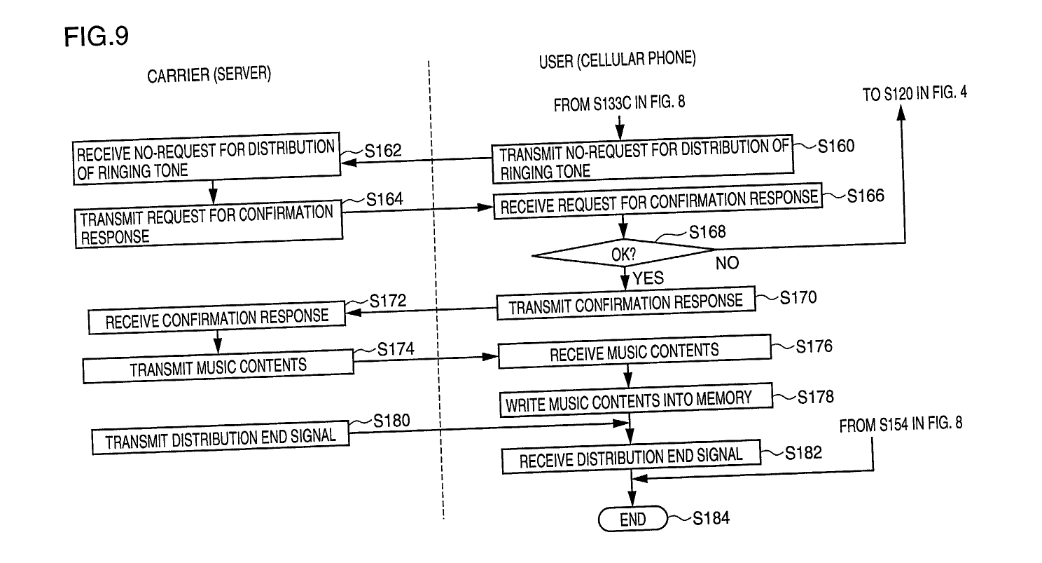

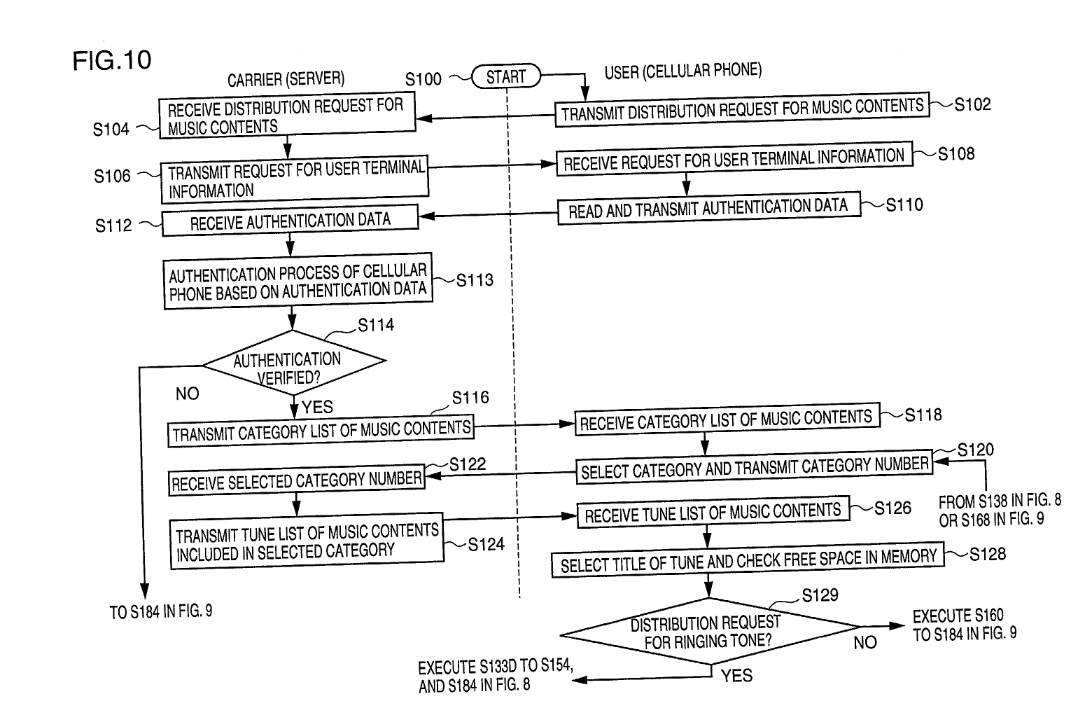

If authentication of cellular phone 10 is verified at step S114, data distribution control unit 52 outputs, to line establishing unit 51, a signal indicating that the authentication of cellular phone 10 is verified, and line establishing unit 51 transmits a category list of music contents held therein to cellular phone 10 via two-way communication (step S116). CPU 103 of cellular phone 10 receives the category list via antenna 100, reception unit 102 and bus BS (step S118), and displays the category list onto display unit 105 via bus BS. Thus, a category list 70 as shown in FIG. 6 is displayed on display unit 105. The user of cellular phone 10 looks at category list 70 displayed on display unit 105 and selects a category of his/her preference. Here, the user selects a category by entering a preferred number 1, 2, 3, 4, or . . . among the category numbers as follows: 1) pops; 2) Enka; 3) jazz; 4) children's songs; . . . . CPU 103 then transmits the entered category number to server 50 via transmission unit 101 and antenna 100 (step S120). Line establishing unit 51 of server 50 receives the selected category number (step S122), and transmits the title list of music contents included in the selected category to cellular phone 10 (step S124).

CPU 103 of cellular phone 10 receives the title list via antenna 100, reception unit 102 and bus BS (step S126), and displays the title list onto display unit 105 via bus BS. That is, CPU 103 displays a title list 71 shown in FIG. 7 onto display unit 105. Title list 71 includes the titles and sizes of music content data. The user selects music content data to be downloaded from the title list displayed on display unit 105 by entering the number 1, 2, 3, or . . . using key operation unit 104. Moreover, CPU 103 checks if there is a free space for storing the selected music content data into memory 106 based on the data size of the music content data corresponding to the number entered via key operation unit 104, and if there is a free space (step S128), then CPU 103 transmits the number of the selected tune to server 50 (step S130). Then, line establishing unit 51 of server 50 receives the selected tune number (step S132).

Referring to FIG. 5, when the tune number is received, line establishing unit 51 transmits a request for confirmation response. In other words, line establishing unit 51 transmits to cellular phone 10 the request for confirmation response, asking: “Are you certain that you have requested such music content data included in such category?” to determine if the music content data for which the distribution request was issued to server 50 by the user of cellular phone 10 is correct (step S134). CPU 103 of cellular phone 10 receives the request for confirmation response via antenna 100, reception unit 102 and bus BS (step S136), and checks the category and title of the music content data of which the distribution request was issued to server 50 (step S138). If the details of the request for confirmation response received from line establishing unit 51 is inconsistent with the distribution request, CPU 103 goes back to step S120 in FIG. 4, and steps S120 to S136 are repeated. If the details of the received request for confirmation response is consistent with the distribution request, CPU 103 transmits a confirmation response to server 50 via bus BS, transmission unit 101 and antenna 100 (S140). Line establishing unit 51 of server 50 receives the confirmation response (step S142), and outputs a signal indicating the reception to data distribution control unit 52.

Subsequently, data distribution control unit 52 extracts music content data selected from music-content data base 531 based on the tune number received by line establishing unit 51, and also extracts a ringing tone from ringing-tone data base 532. Data distribution control unit 52 then transmits the music content data and ringing tone to cellular phone 10 (step S144).

CPU 103 of cellular phone 10 receives the music content data and ringing tone via antenna 100, reception unit 102 and bus BS (step S146), and writes the received music content data and ringing tone into memory 106 via bus BS (step S148).

When transmission of the music content data and ringing tone is terminated, data distribution control unit 52 of server 50 transmits the distribution end signal to cellular phone 10 (step S150). When the distribution end signal is received via antenna 100, reception unit 102 and bus BS (step S152), CPU 103 of cellular phone 10 reads a ringing tone from memory 106 via bus BS, and supplies the read ringing tone to ringing tone generating unit 107 via bus BS. Thus, the ringing tone is newly set to ringing tone generating unit 107 (step S154). Then, distribution operation for the music content data and ringing tone is terminated (step S156).

In the distribution operation for music content data and ringing tones, steps S100 to S156 in the flow chart shown in FIGS. 4 and 5 are generally performed in a connected state in which the line is established between cellular phone 10 and server 50. In the present invention, processes from step S100 of FIG. 4 to step S142 of FIG. 5 may be performed in the connected state, and processes of steps S144 to S156 may be performed in a disconnected state in which the line is not established between cellular phone 10 and server 50. Reception of music content data and ringing tones in the disconnected state means that the data is received while cellular phone 10 is in a standby state. Here, the music content data and ringing tones are transmitted to cellular phone 10 via packet transmission.

If there is an incoming call from another cellular phone after a ringing tone is set to ringing tone generating unit 107, CPU 103 outputs a signal indicating the incoming call to ringing tone generating unit 107 via bus BS. When the signal indicating the incoming call is received, ringing tone generating unit 107 generates a ringing tone in accordance with the set ringing tone, and supplies the generated ringing tone to sound input/output unit 110 via bus BS. Thereafter, sound input/output unit 110 emits the ringing tone to the outside. The user of cellular phone 10 listens to the newly received ringing tone to know that there is an incoming call.

Moreover, CPU 103 of cellular phone 10 reads music content data from memory 106 via bus BS according to a request for regenerating music content data from key operation unit 104, and supplies the read music content data to audio decoding unit 109 via bus BS. Audio decoding unit 109 decodes the input music content data. CPU 103 then supplies the decoded music content data to sound input/output unit 110, and sound input/output unit 110 outputs the music content data to the outside. This allows the user of cellular phone 10 to listen to the music content data downloaded from server 50.

As described above, the user of cellular phone 10 can simultaneously receive desired music content data and ringing tone from server 50 via the existing telephone communication network 30.

Distribution operation for music content data according to the present invention may be performed as described below. That is, steps S100 to S132 shown in FIG. 4 may be executed, and thereafter each step shown in FIGS. 8 and 9 may be executed. After step S132 in FIG. 4, line establishing unit 51 of server 50 outputs the received tune number to data distribution control unit 52. Thereafter, data distribution control unit 52 selects a ringing tone from ringing-tone data base 532 and regenerates the ringing tone in a regenerating unit (not shown), and thereafter supplies the regenerated ringing tone to line establishing unit 51. Line establishing unit 51 then transmits the regenerated ringing tone to cellular phone 10 via two-way communication (step S133A).

CPU 103 of cellular phone 10 receives the regenerated ringing tone via antenna 100, reception unit 102 and bus BS, and supplies the received ringing tone to sound input/output unit 110 via bus BS. Sound input/output unit 110 then outputs the regenerated ringing tone to the outside, and the user test-listens to the ringing tone (step S133B). If the user desires distribution of the ringing tone after test-listening of the ringing tone, he/she enters a distribution request for the ringing tone via key operation unit 104. On the other hand, if the user desires no distribution of the ringing tone after the test-listening, the user enters a no-request for distribution of the ringing tone via key operation unit 104.

CPU 103 determines whether or not the user requests distribution of the ringing tone (step S133C), and if the distribution request for the ringing tone is received via key operation unit 104, CPU 103 transmits the distribution request for the ringing tone to server 50 via bus BS, transmission unit 101 and antenna 100 (step S133D).

Line establishing unit 51 of server 50 then receives the distribution request for the ringing tone (step S133E). Thereafter, steps S134 to S154 described with reference to FIG. 5 are executed, and the process moves on to step S184 in FIG. 9.

On the other hand, if it is determined that no request is issued for distribution of the ringing tone in step S133C, the process moves on to step S160 in FIG. 9. Here, CPU 103 of cellular phone 10 transmits a no-request for distribution of the ringing tone to server 50 via bus BS, transmission unit 101 and antenna 100 (step S160). Thereafter, line establishing unit 51 of server 50 receives the no-request for distribution of the ringing tone (step S162). Subsequently, line establishing unit 51 transmits a request for confirmation response. In other words, line establishing unit 51 transmits the request for confirmation response to cellular phone 10, asking: “Are you certain that you have requested such music content data included in such category? No request for distribution of the ringing tone?” to determine if the distribution request for the music content data issued to server 50 by the user of cellular phone 10 is correct (step S164). CPU 103 of cellular phone 10 receives the request for confirmation response via antenna 100, reception unit 102 and bus BS (step 166), and checks the category and title of the music content data of which the distribution request was issued to server 50 (step S168). If the details of the received request for confirmation response is inconsistent with the those of the distribution request, CPU 103 goes back to step S120 in FIG. 4, and steps S120 to S132 in FIG. 4, steps S133A to S133C in FIG. 8, and steps S160 to S168 in FIG. 9 are repeated. If the details of the received request for confirmation response is consistent with the details of the distribution request, CPU 103 transmits a confirmation response to server 50 via bus BS, transmission unit 101 and antenna 100 (S170). Line establishing unit 51 of server 50 receives the confirmation response (step S172), and outputs a signal indicating the reception of the confirmation response to data distribution control unit 52.

Data distribution control unit 52 then extracts the selected music content data from music-content data base 531 based on the tune number received by line establishing unit 51. Here, as data distribution control unit 52 has received the no-request for distribution of the ringing tone from cellular phone 10, no ringing tone is read out from ringing-tone data base 532. Data distribution control unit 52 then transmits the music content data to cellular phone 10 (step S174).

CPU 103 of cellular phone 10 receives the music content data via antenna 100, reception unit 102 and bus BS (step S176), and writes the received music content data into memory 106 via bus BS (step S178).

When the transmission of music content data is terminated, data distribution control unit 52 of server 50 transmits the distribution end signal to cellular phone 10 (step S180). CPU 103 of cellular phone 10 receives the distribution end signal via antenna 100, reception unit 102 and bus BS (step S182), and then the distribution operation for music content data is terminated (step S184).

In the distribution operation for music content data according to the flow charts shown in FIGS. 4, 8 and 9, the user can have a ringing tone distributed from server 50 only when he/she likes the ringing tone after test-listening. Therefore, the user can set only a desired ringing tone to his/her cellular phone 10.

Distribution operation for music content data according to the present invention may be performed as described below. That is, steps S100 to S129 shown in FIG. 10 may be executed, and thereafter steps S133D to S154 in FIG. 8 or steps S160 to S184 shown in FIG. 9 may be executed.

Steps S100 to S128 in FIG. 10 are the same as steps S100 to S128 shown in FIG. 4. Subsequent to step S128, CPU 103 of cellular phone 10 determines whether or not a distribution request for a ringing tone is issued (step S129), and if the distribution request for ringing tone is issued, the process moves on to step S133D in FIG. 8, and steps S133D to S154 are executed. This means that the steps performed in the example above where the distribution request for the ringing tone was issued are executed. On the other hand, if it is determined that CPU 103 issues no request for distribution of the ringing tone at step S129, the process moves on to step S160 in FIG. 9, and steps S160 to S184 are executed. This means that the steps performed in the example above where no request was issued for the distribution of ringing tone are executed.

According to the flow chart shown in FIG. 10, the user of cellular phone 10 is not required to receive a ringing tone every time he/she makes a distribution request for music content data to server 50, but rather can receive the ringing tone only when he/she desires reception thereof.

The ringing tone received through the distribution operation for music content data as described above may not be set to ringing tone generating unit 107 simultaneously with the reception thereof. The user of cellular phone 10 can set the ringing tone whenever he/she wishes to. When the user wishes, he/she enters a request for setting the ringing tone (hereinafter also referred to as setting request) via key operation unit 104. CPU 103 then reads the ringing tone from memory 106 in accordance with the setting request, and sets the read ringing tone to ringing tone generating unit 107. This enables the user to set the ringing tone to cellular phone 10 at a desired timing.

Moreover, in the above-described distribution operation for music content data, the user of cellular phone 10 pays for reception of the music content data. Thus, the user of cellular phone 10 pays only for the music content data even if a ringing tone is received together with the music content data. Furthermore, the user of cellular phone 10 can receive a desired ringing tone at a desired timing by using various ways of distribution operation described above.

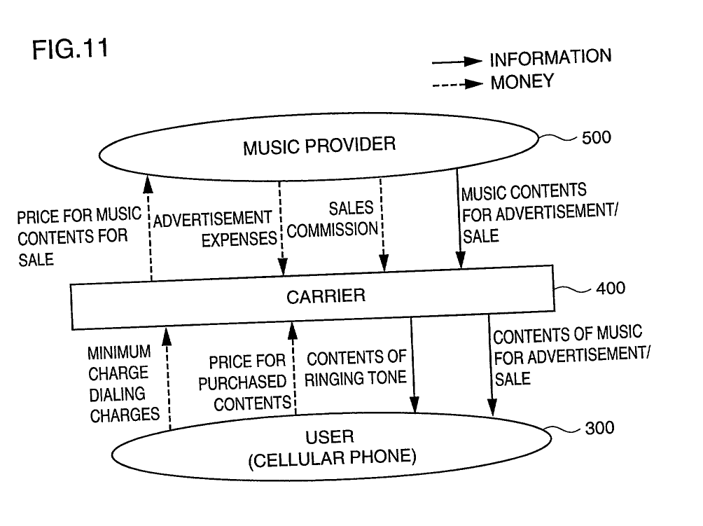

Referring to FIG. 11, a business model for distributing music content data is described. It is noted that, in FIG. 11, arrows of solid lines indicates the flow of information, whereas the arrows of dotted lines indicate the flow of money.

User 300 requests a supplier 400 to distribute music content data and a ringing tone using cellular phone 10 according to the system described above, and pays the minimum charge, dialing charges and the prices for purchased contents to supplier 400 in return. In this case, user 300 only pays the price for the purchased music content data. Thus, user 300 can receive the ringing tone free of charge.

Supplier 400 is provided with music content data from a music provider 500, and advertises and sells the music content data to user 300. Supplier 400 collects advertising expenses and a sales commission from music provider 500 and pays the prices for music contents for sale to music provider 500.

On the whole, supplier 400 transmits music content data and ringing tones in accordance with the distribution request for music content data from user 300, and collects the prices for the music content data from user 300 in return. In addition, supplier 400 pays the prices for the music content data for sale to music provider 500, and collects the advertisement expenses and sales commission of music content data from music provider 500. This allows supplier 400 to use a ringing tone as an advertisement of music content data. If the user likes the ringing tone, supplier 400 receives distribution request for the music content data including the ringing tone. Thus, supplier 400 can increase the sales figures of the music content data. If the sales figures of the music content data are increased, supplier 400 pays more for the music content data to music provider 500. As a result, music provider 500 pays more advertising expenses and sales commission to supplier 400. This results in a positive feedback, allowing supplier 400 and music provider 500 to have increased income, while user 300 receives desired music content data and ringing tone to set the received ringing tone to his/her cellular phone.

Though an example of distributing a ringing tone together with the music content data to cellular phone 10 was described above, content data is not limited to the music content data, and other content data such as image data, map data and so forth may also be employed. In the present invention, a ringing tone may be distributed with any content data as long as the user of the cellular phone can automatically set the ringing tone to his/her cellular phone. Moreover, considering the recent functional enhancement of cellular phones, a cellular phone may receive image data or map data to use the data as a navigator. Thus, a ringing tone may also be distributed to a cellular phone together with image data and map data.

Although the present invention has been described and illustrated in detail, it is clearly understood that the same is by way of illustration and example only and is not to be taken by way of limitation, the spirit and scope of the present invention being limited only by the terms of the appended

What is claimed is:

1. A distribution system, comprising:
a server holding content data and a ringing tone, and distributing said content data and said ringing tone in accordance with a distribution request for said content data; and
a cellular phone transmitting the distribution request for said content data to said server, and receiving said ringing tone together with said content data from said server.

2. The distribution system according to claim 1, wherein
said cellular phone transmits authentication data in accordance with a request for transmission of the authentication data from said server, and receives said content data and said ringing tone in response to authentication of said authentication data being verified by said server.

3. The distribution system according to claim 1, wherein
said server extracts and regenerates a ringing tone in response to the distribution request for said content data, and transmits the regenerated ringing tone to said cellular phone, and
said cellular phone transmits the distribution request for said ringing tone to said server in response to the distribution request for said ringing tone being entered.

4. The distribution system according to claim 1, wherein
said cellular phone receives said ringing tone only when the distribution request for said ringing tone is transmitted to said server.

5. The distribution system according to claim 1, wherein
said content data is music data, and
said server distributes to said cellular phone, as said ringing tone, a tune related to music data for which the distribution request is issued.

6. The distribution system according to claim 1, wherein
said content data is music data, and
said server distributes to said cellular phone, as said ringing tone, a part of music data for which the distribution request is issued at least a predetermined number of times.

7. The distribution system according to claim 1, wherein
said content data is music data, and
said server distributes to said cellular phone a ringing tone determined based on a category to which requested music data belongs.

8. The distribution system according to claim 1, wherein
said cellular phone receives said content data and said ringing tone from said distribution server while no telephone call is in progress.

9. The distribution system according to claim 1, wherein
a user of said cellular phone only pays a price for said content data to said server.

10. A cellular phone receiving a ringing tone together with content data from a server holding said content data and said ringing tone, comprising:
a transmission/reception unit communicating with said server;
a memory unit storing said content data and said ringing tone;
a ringing tone generating unit;
a key operation unit for entering an instruction; and
a control unit,
said control unit transmitting a distribution request for said content data entered from said key operation unit to said server via said transmission/reception unit in response to said distribution request, inputting said content data and said ringing tone received via said transmission/reception unit into said memory unit, and setting said received ringing tone to said ringing tone generating unit,
said ringing tone generating unit generating said set ringing tone when said control unit receives a normal call via said transmission/reception unit.

11. The cellular phone according to claim 10, wherein
said control unit reads authentication data stored in said memory unit in response to a request for transmission of the authentication data from said server, transmits the read authentication data to said server via said transmission/reception unit, and receives said content data and said ringing tone via said transmission/reception unit in response to authentication of said authentication data being verified by said server.

12. The cellular phone according to claim 10, wherein
said control unit receives said ringing tone only when the distribution request for said ringing tone is transmitted to said server via said transmission/reception unit.

13. The cellular phone according to claim 10, further comprising:
an output unit outputting said ringing tone to outside the cellular phone,
said control unit receiving a ringing tone regenerated at said server via said transmission/reception unit, supplying the received ringing tone to
said output unit, and transmitting the distribution request for said ringing tone to said server via said transmission/reception unit in response to the distribution request for said ringing tone being entered via said key operation unit.

14. The cellular phone according to claim 10, wherein
said content data is music data, and
said control unit receives, as said ringing tone, a tune related to music data for which the distribution requested is issued.

15. The cellular phone according to claim 10, wherein
said content data is music data, and
said control unit receives, as said ringing tone, a part of music data for which the distribution request is issued to said server at least a predetermined number of times.

16. The cellular phone according to claim 10, wherein
said content data is music data, and
said control unit receives a ringing tone determined based on a category to which requested music data belongs.

17. The cellular phone according to claim 10, wherein
said control unit receives said content data and said ringing tone while no telephone call is in progress.

18. The cellular phone according to claim 10, wherein
said control unit reads said received ringing tone from said memory unit in accordance with a request for setting a ringing tone entered via said key operation unit, and supplies the read ringing tone to said ringing tone generating unit.

19. A distribution system, comprising:
a cellular phone issuing a distribution request for content data, receiving said content data and a ringing tone, and setting said ringing tone;
a supplier distributing said content data and said ringing tone to said cellular phone in response to the distribution request for said content data from said cellular phone; and
a content provider providing said supplier with said content data,
a user of said cellular phone pays only a price for said content data to said supplier,
said supplier pays a price for said content data to said content provider, and receives an advertisement expense and a sales commission for said content data from said content provider.
